(19) United States
(12) Patent Application Publication
(10) Pub. No.: US 2014/0342676 A1
(43) Pub. Date: Nov. 20, 2014

(54) MATCHING CIRCUIT AND WIRELESS COMMUNICATION DEVICE USING THE SAME

(71) Applicant: Chiun Mai Communication Systems, Inc., New Taipei (TW)

(72) Inventors: TZE-HSUAN CHANG, New Taipei (TW); CHO-KANG HSU, New Taipei (TW)

(73) Assignee: Chiun Mai Communication Systems, Inc., New Taipei (TW)

(21) Appl. No.: 14/014,306

(22) Filed: Aug. 29, 2013

(30) Foreign Application Priority Data
May 17, 2013 (TW) 102117549

(51) Int. Cl. H04B 1/40

(52) U.S. Cl. CPC H04B 1/40
USPC 455/77

(57) ABSTRACT

A matching circuit electronically connected between an antenna and a radio frequency (RF) module includes a first admittance circuit and a second admittance circuit. The first admittance circuit is electronically connected between the antenna and the RF module. The first admittance circuit is configured to adjust resonance frequencies of the antenna at multiple frequency bands by changing an admittance of the first admittance circuit. A first end of the second admittance circuit is electronically connected between the RF module and the first admittance circuit. A second end of the second admittance circuit is grounded. The second admittance circuit is configured to reduce the first admittance circuit from influence of high frequency signals.

### BACKGROUND

1. Technical Field

The disclosure generally relates to matching circuits, and particularly to a matching circuit for a multiband antenna of a wireless communication device and the wireless communication device using the matching circuit.

2. Description of Related Art

Because of miniaturization of wireless communication devices, space occupied by an antenna is compressed and limited. To widen the frequency band of the antenna and ensure that a high radio efficiency of the antenna is maintained, a matching circuit is employed to match an input impedance of the antenna. However, generally, one matching circuit is only suitable for one corresponding frequency band such as 880-960 MHz or 824-894 MHz. When the matching circuit is used to provide impedance matching for the antenna in a low frequency band, a high frequency band of the antenna cannot be matched. Another matching circuit for the high frequency band and a switch must be added which will occupy additional space and cost more.

Therefore, there is room for improvement within the art.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the disclosure.

FIG. 1 is a block diagram of a wireless communication device comprising a matching circuit, according to a first exemplary embodiment of the disclosure.

FIG. 2 is a block diagram of a wireless communication device comprising a matching circuit, according to a second exemplary embodiment of the disclosure.

FIG. 3 is a block diagram of a wireless communication device comprising a matching circuit, according to a third exemplary embodiment of the disclosure.

FIG. 4 is a block diagram of a wireless communication device comprising a matching circuit, according to a fourth exemplary embodiment of the disclosure.

FIG. 5 is a block diagram of a wireless communication device comprising a matching circuit, according to a fifth exemplary embodiment of the disclosure.

FIG. 6 is a block diagram of a wireless communication device having a matching circuit, according to a sixth exemplary embodiment of the disclosure.

FIG. 7 is a block diagram of a wireless communication device comprising a matching circuit, according to a seventh exemplary embodiment of the disclosure.

FIG. 8 is a block diagram of a wireless communication device comprising a matching circuit, according to an eighth exemplary embodiment of the disclosure.

FIG. 9 is a diagram showing return loss measurements of an antenna of the wireless communication device shown in FIG. 5.

FIG. 10 is a diagram showing efficiency measurements of the antenna of the wireless communication device shown in FIG. 5.

### DETAILED DESCRIPTION

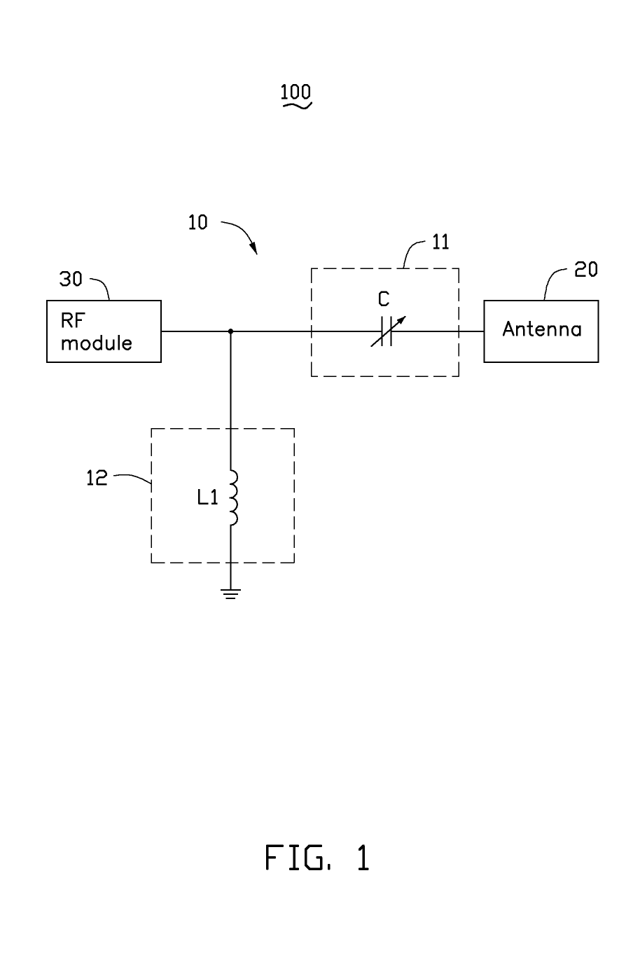

FIG. 1 is a block diagram of a wireless communication device 100 having a matching circuit 10, according to a first exemplary embodiment of the disclosure. The wireless communication device 100 may be a mobile phone and includes an antenna 20 and a radio frequency (RF) module 30. The matching circuit 10 is electronically connected between the antenna 20 and the RF module 30.

The antenna 20 is configured to receive electronic signals transmitted from the RF module 30 and convert the electronic signals into radio waves and also transmit the radio waves received from other wireless communication devices to the RF module 30. The antenna 20 can transmit and receive signals at multiple frequency bands.

The matching circuit 10 includes a first admittance circuit 11 and a second admittance circuit 12. The first admittance circuit 11 is electronically connected in series between the antenna 20 and the RF module 30. A first end of the second admittance circuit 12 is electronically connected between the first admittance circuit 11 and the RF module 30. A second end of the second admittance circuit 12 is grounded.

In the first exemplary embodiment, the first admittance circuit 11 includes a variable capacitor C. The second admittance circuit 12 includes a first inductor L1. A first end of the first inductor L1 is electronically connected between the RF module 30 and the variable capacitor C. A second end of the second inductor L1 is grounded. A capacitance of the variable capacitor C can be adjusted by a control circuit (not shown) such as a microcontroller unit of the wireless communication device 100 according to the working frequency band of the antenna 20 to providing impedance matching for the antenna 20 with the first inductor L1 together so that a low resonance frequency of the antenna 20 can satisfy radio requirements at different working frequency bands.

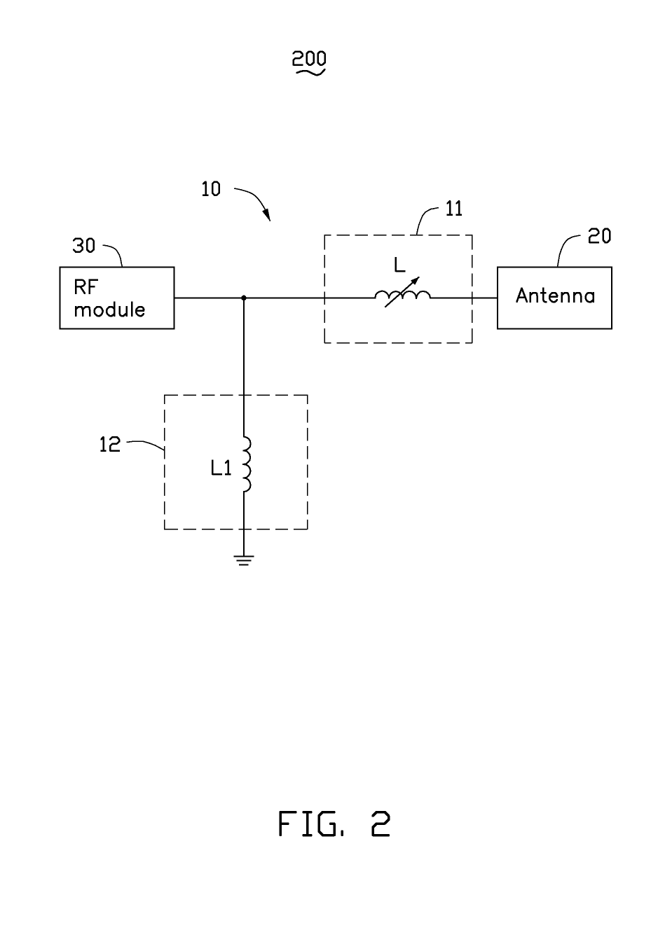

FIG. 2 is a block diagram of a wireless communication device 200, according to a second exemplary embodiment of the disclosure. The wireless communication device 200 is substantially similar to the wireless communication device 100. Difference between the wireless communication device 200 and the communication device 100 is that the first admittance circuit 11 includes a variable inductor L electronically connected between the antenna 20 and the RF module 30, replaces the variable capacitor C.

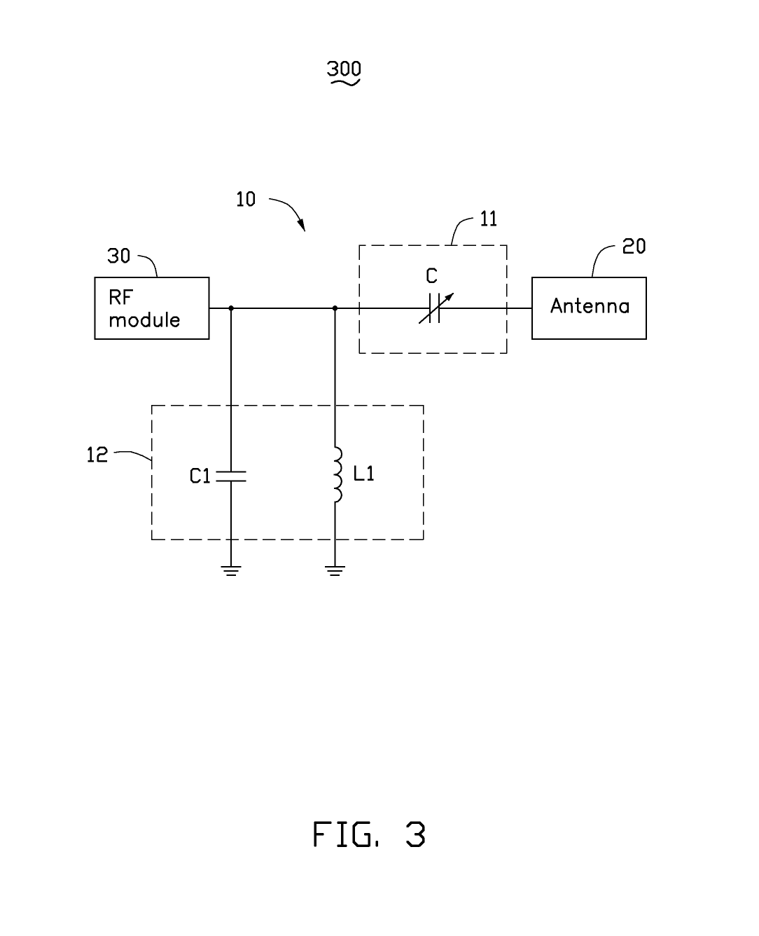

FIG. 3 is a block diagram of a wireless communication device 300, according to a third exemplary embodiment of the disclosure. The wireless communication device 300 is substantially similar to the wireless communication device 100. Difference between the wireless communication device 300 and the communication device 100 is that the second admittance circuit 12 further includes a first capacitor C1 electronically connected to the first inductor L1 in parallel. The first capacitor C1 is configured to reduce the first inductor L1 from influence of high frequency signals.

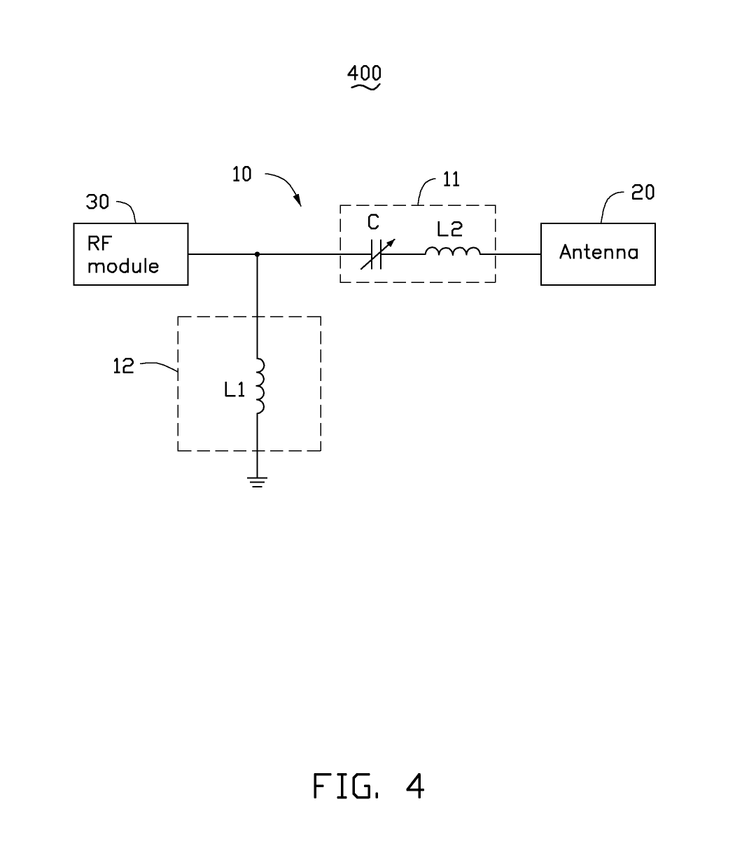

FIG. 4 is a block diagram of a wireless communication device 400, according to a fourth exemplary embodiment of the disclosure. The wireless communication device 400 is substantially similar to the wireless communication device 100. Difference between the wireless communication device 400 and the communication device 100 is that the first admittance circuit 11 further includes a second inductor L2 electronically connected to the variable capacitor C in series. The second inductor L2 is electronically connected between the variable capacitor C and the antenna 20. The second inductor L2 can be a variable inductor.

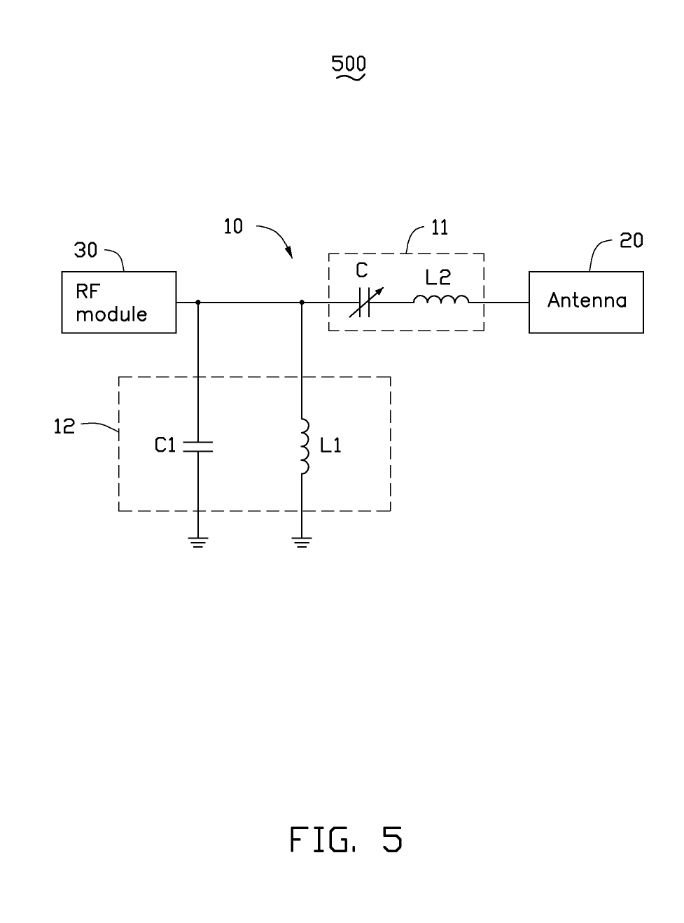

FIG. 5 is a block diagram of a wireless communication device 500, according to a fifth exemplary embodiment of the disclosure. The wireless communication device 500 is substantially similar to the wireless communication device 400. Difference between the wireless communication device 500 and the communication device 400 is that the second admittance circuit 12 further includes a first capacitor C1 electronically connected to the first inductor L1 in parallel. The first capacitor C1 is configured to reduce the first inductor L1 from influence of high frequency signals. A first end of the first capacitor C1 is electronically connected between the first inductor L1 and the RF module 30. A second end of the first capacitor C1 is grounded.

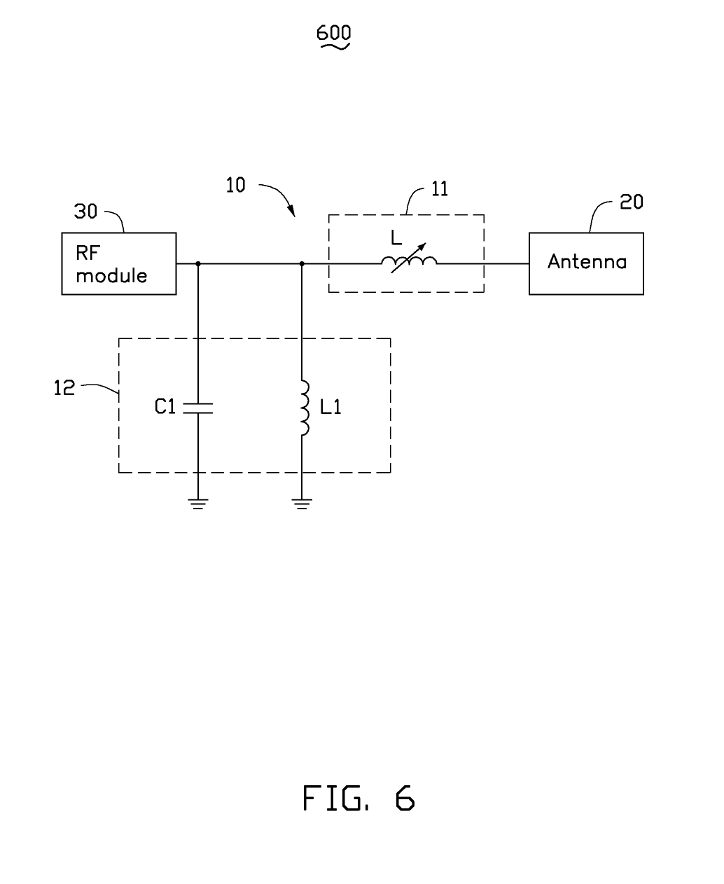

FIG. 6 is a block diagram of a wireless communication device 600, according to a sixth exemplary embodiment of the disclosure. The wireless communication device 600 is substantially similar to the wireless communication device 200. Difference between the wireless communication device 600 and the communication device 200 is that the second admittance circuit 12 further includes a first capacitor C1 electronically connected to the first inductor L1 in parallel. The first capacitor C1 is configured to reduce the first inductor L1 from influence of high frequency signals. A first end of the first capacitor C1 is electronically connected between the first inductor L1 and the RF module 30. A second end of the first capacitor C1 is grounded.

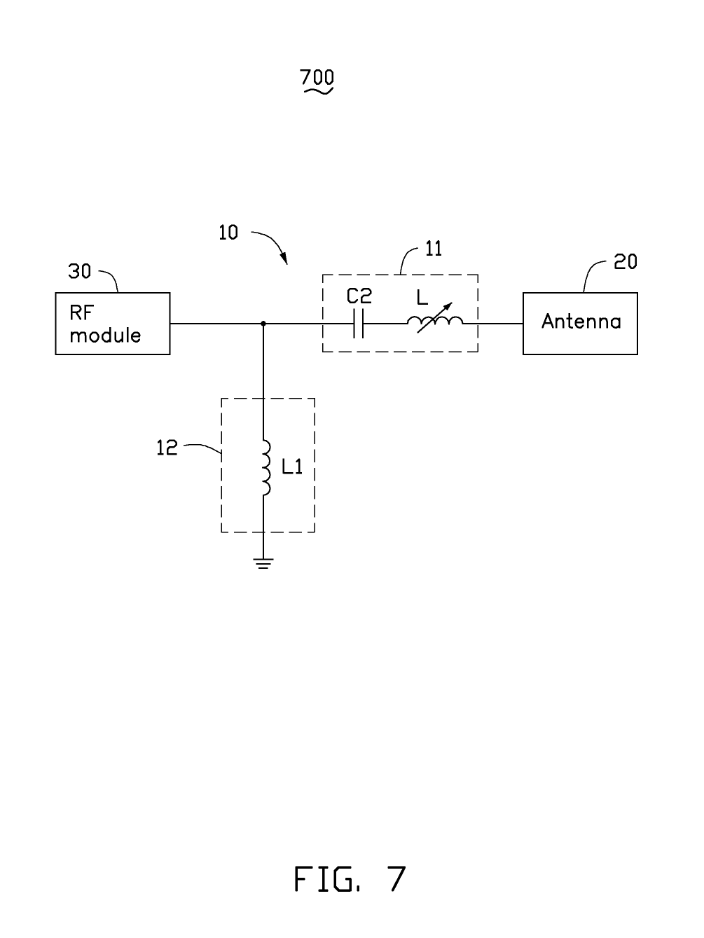

FIG. 7 is a block diagram of a wireless communication device 700, according to a seventh exemplary embodiment of the disclosure. The wireless communication device 700 is substantially similar to the wireless communication device 200. Difference between the wireless communication device 700 and the communication device 200 is that the first admittance circuit 11 further includes a second capacitor C2 electronically connected to the variable inductor L in series. The second capacitor C2 is configured to reduce the first inductor L1 from influence of high frequency signals. The second capacitor C2 is electronically connected between the variable inductor L and the RF module 30.

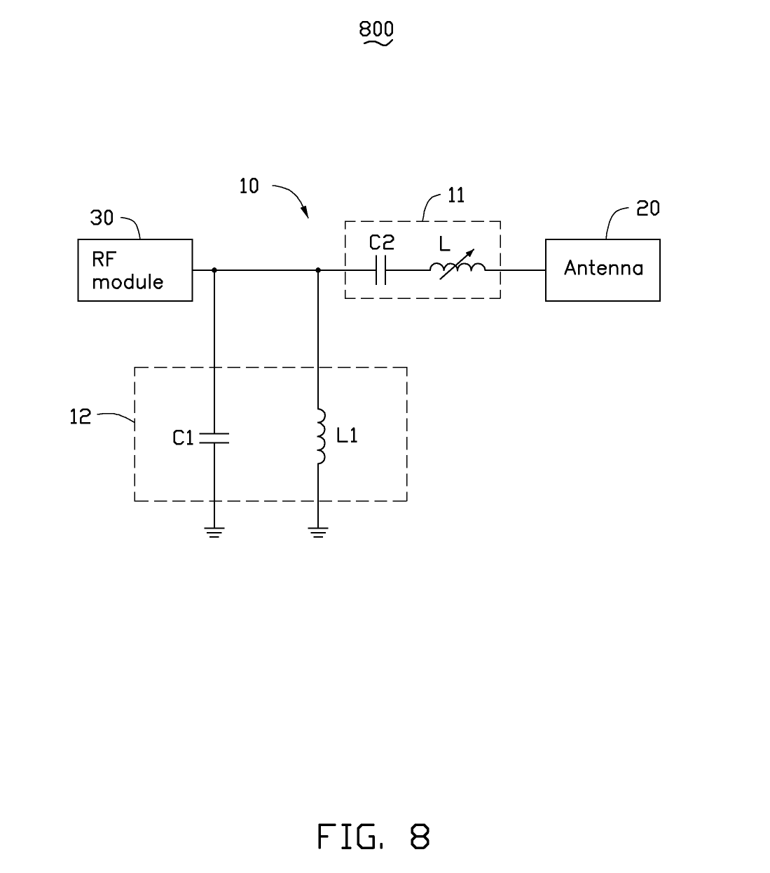

FIG. 8 is a block diagram of a wireless communication device 800, according to an eighth exemplary embodiment of the disclosure. The wireless communication device 800 is substantially similar to the wireless communication device 700. Difference between the wireless communication device 800 and the wireless communication device 700 is that the second admittance circuit 12 further includes a first capacitor C1 electronically connected to the first inductor L1 in parallel. The first capacitor C1 is configured to reduce the first inductor L1 from influence of high frequency signals. A first end of the first capacitor C1 is electronically connected between the first inductor L1 and the RF module 30. A second end of the first capacitor C1 is grounded.

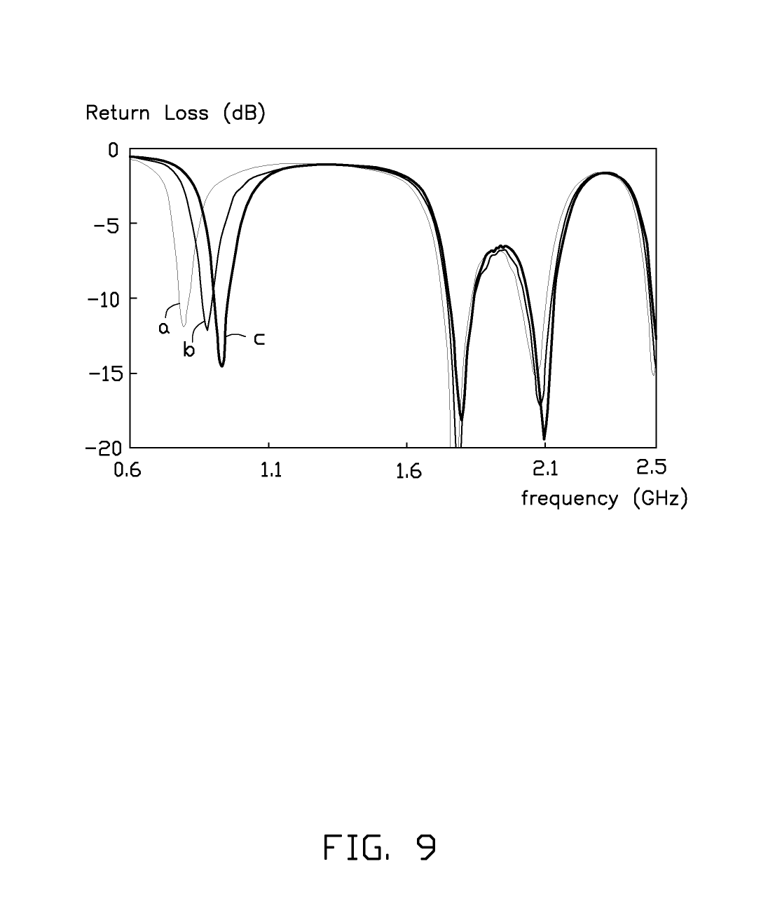

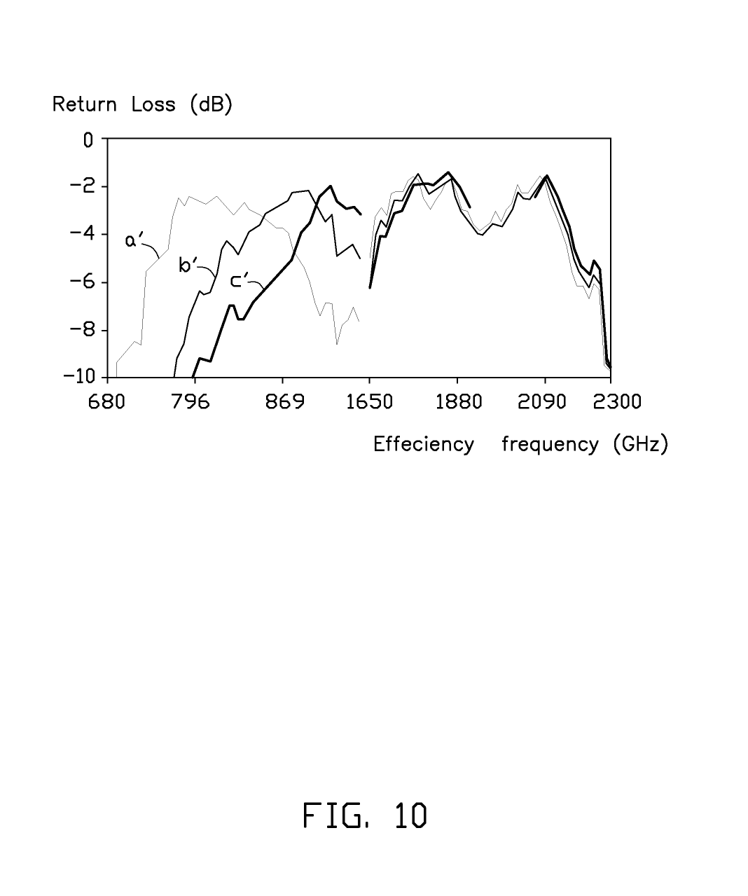

FIGS. 9 and 10 show that curves a, b, and c represent return loss and radio efficiencies of the antenna 20 obtained by changing the capacitance of the variable capacitor C. According to the measurement results, the working frequency band in a high frequency of the antenna and in a low frequency adjusted from 746 MHz to 980 MHz have better radio efficiencies.

The first admittance circuit 11 can provide impedance matching for the antenna 20 at multiple working frequency bands to adjust the resonance frequency of the antenna 20 in a low frequency. Moreover, the first capacitor C1, the second capacitor C2, and the inductor L2 are used to reduce influence of the matching circuit 10 to the high frequency signals.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A matching circuit electronically connected between an antenna and a radio frequency (RF) module, the matching circuit comprising:
a first admittance circuit electronically connected in series between the antenna and the RF module, the first admittance circuit configured to adjust resonance frequencies of the antenna at multiple frequency bands by changing an admittance of the first admittance circuit; and
a second admittance circuit; wherein a first end of the second admittance circuit is electronically connected between the RF module and the first admittance circuit, and a second end of the second admittance circuit is grounded; the second admittance circuit is configured to reduce the first admittance circuit from influence of to high frequency signals.

2. The matching circuit of claim 1, wherein the first admittance circuit comprises a variable capacitor electronically connected between the antenna and the RF module; the second admittance circuit comprises a first inductor, a first end of the first inductor is electronically connected between the RF module and the variable capacitor; a second end of the first inductor is grounded.

3. The matching circuit of claim 2, wherein the second admittance circuit further comprises a first capacitor, a first end of the first capacitor is electronically connected between the first inductor and the RF module, the second end of the first capacitor is grounded.

4. The matching circuit of claim 2, wherein the first admittance circuit further comprises a second inductor connected between the variable capacitor and the antenna.

5. The matching circuit of claim 4, wherein the second admittance circuit further comprises a first capacitor, a first end of the first capacitor is electronically connected between the first inductor and the RF module, the second end of the first capacitor is grounded.

6. The matching circuit of claim 1, wherein the first admittance circuit comprises a variable inductor electrically connected between the antenna and the RF module, a second admittance comprises a first inductor, a first end of the first inductor is electronically connected between the RF module and the variable conductor; a second of the first inductor is grounded.

7. The matching circuit of claim 6, wherein the second admittance circuit comprises a first capacitor, a first end of the first capacitor is electronically between the first inductor and the RF module, a second end of the second capacitor is grounded.

8. The matching circuit of claim 6, wherein the first admittance circuit further comprises a second capacitor electronically connected between the RF module and the variable inductor.

9. The matching circuit of claim 6, wherein the first admittance circuit further comprises a first capacitor, a first end of the first capacitor is electronically connected between the first inductor and the RF module, the second end of the first capacitor is grounded.

10. A wireless communication device, comprising:
an antenna;
a radio frequency (RF) module; and
a matching circuit connected between the antenna and RF module, the matching circuit comprising:
a first admittance circuit electronically connected between the antenna and RF module, the first admittance circuit configured to adjust resonance frequencies of the antenna at multiple frequency bands by changing an admittance of the first admittance circuit; and a second admittance circuit; wherein a first end of the second admittance circuit is electronically connected between the RF module and the first admittance circuit, and a second end of the second admittance circuit is grounded; the second admittance circuit is configured to reduce influence of the first admittance circuit to high frequency signals.

11. The wireless communication device of claim 9, wherein the first admittance circuit comprises a variable capacitor electronically connected between the antenna and the RF module; the second admittance circuit comprises a first inductor, a first end of the first inductor is electronically connected between the RF module and the variable capacitor; a second end of the first inductor is grounded.

12. The wireless communication device of claim 11, wherein the second admittance circuit further comprises a first capacitor, a first end of the first capacitor is electronically connected between the first inductor and the RF module, the second end of the first capacitor is grounded.

13. The wireless communication device of claim 11, wherein the first admittance circuit further comprises a second inductor connected between the variable capacitor and the antenna.

14. The wireless communication device of claim 13, wherein the second admittance circuit further comprises a first capacitor, a first end of the first capacitor is electronically connected between the first inductor and the RF module, the second end of the first capacitor is grounded.

15. The wireless communication device of claim 10, wherein the first admittance circuit comprises a variable inductor electrically connected between the antenna and the RF module, a second admittance comprises a first inductor, a first end of the first inductor is electronically connected between the RF module and the variable conductor; a second of the first inductor is grounded.

16. The wireless communication device of claim 15, wherein the second admittance circuit comprises a first capacitor, a first end of the first capacitor is electronically between the first inductor and the RF module, a second end of the second capacitor is grounded.

17. The wireless communication device of claim 16, wherein the first admittance circuit further comprises a second capacitor electronically connected between the RF module and the variable inductor.

18. The wireless communication device of claim 16, wherein the first admittance circuit further comprises a first capacitor, a first end of the first capacitor is electronically connected between the first inductor and the RF module, the second end of the first capacitor is grounded.
